(19) United States
(12) Patent Application Publication
(10) Pub. No.: US 2025/0258507 A1
(43) Pub. Date: Aug. 14, 2025

(54) HEATING DEVICE AND METHOD WITH VAPOR PRESSURE DEFICIT CONTROL

(71) Applicant: AC Infinity Inc., City of Industry, CA (US)

(72) Inventors: Jimmy Liu, Brea, CA (US); Daniel Yu Hsu, Upland, CA (US); Wilbur Y. Cheng, Chino Hills, CA (US); Wei Ying Shao, Alhambra, CA (US)

(21) Appl. No.: 18/438,240

(22) Filed: Feb. 9, 2024

(51) Int. Cl. A01G 9/24

(52) U.S. Cl. CPC G05D 22/02; F24F 11/0008; G05D 23/1902

(57) ABSTRACT

A heating device with VPD control for indoor residential cannabis cultivation includes a control module with a processing unit, a display screen and an IO interface; a heater for providing heat and a fan for circulating heat in response to a control signal from the control module; and a temperature-humidity sensor for sensing an environmental temperature value T and an environmental relative humidity value RH within an indoor cannabis cultivation environment. The environmental temperature value T and the environmental relative humidity value RH are transmitted to the control module in real time, and a VPD value is calculated from the environmental temperature value T and the environmental relative humidity value RH by the processing unit of the control module. The VPD value is compared with a pre-determined VPD threshold value to determine running modes of the heater and the fan to control the VPD within the indoor cannabis cultivation environment.

### FIELD OF INVENTION

This invention relates to vapor pressure deficiency control device and method for indoor plant cultivation, and in particular to vapor pressure deficiency control device and method for residential indoor cannabis cultivation to increase cannabis yields.

### BACKGROUND OF INVENTION

Commercial indoor plant growers use temperature and humidity parameters to fine tune their cultivation environment to increase plant yield, but for emerging residential indoor growers, they often lack the tools needed to maintain an optimal growing environment with temperature and humidity. Such tools include for example, humidifier, dehumidifier, air conditioner, and heater.

An object of the invention is to provide an improved and efficient device and method to control the residential indoor cannabis cultivation environment using vapor pressure deficiency (“VPD” hereafter.) By utilizing VPD, residential growers can eliminate at least one or two of the above-mentioned expensive equipment's while still maintaining the same optimal cultivation environment as long as the temperature and humidity of the cultivation space does not reach extreme levels. This is because both the heater and the dehumidifier are able to increase VPD, while both the air conditioner and humidifier are able to decrease VPD.

### SUMMARY OF INVENTION

Vapor Pressure Deficit, or VPD, plays a crucial role in plant indoor cultivation, especially high valued plants, such as cannabis. VPD is the difference between moisture that is currently in the air and how much moisture the air can hold at saturation, or dew point under certain conditions.

According to an embodiment of the invention, a heating device with VPD control for indoor residential cannabis cultivation is disclosed. The heating device with VPD control includes: a control module with a processing unit, a display screen and an IO interface; a heater for providing heat in response to a heater control signal from the control module; a fan for circulating heat in response to a fan control signal from the control module; and a temperature-humidity sensor for sensing an environmental temperature value T and an environmental relative humidity value RH within an indoor cannabis cultivation environment, the environmental temperature value T and the environmental relative humidity value RH are transmitted to the control module in real time, and a leaf VPD value is calculated from the environmental temperature value T and the environmental relative humidity value RH by the processing unit of the control module.

According to an embodiment of the invention, the leaf VPD value is compared with a pre-determined VPD threshold value to determine running modes of the heater and the fan to control adjust the leaf VPD value within the indoor cannabis cultivation environment, and the control module transmits the heater control signal to the heater and the fan control signal to the fan to adjust the environmental temperature value T and the environmental relative humidity value RH within the indoor cannabis cultivation environment.

According to an embodiment of the invention, the temperature-humidity sensor senses an updated environmental temperature value T and an updated environmental relative humidity value RH within the indoor cannabis cultivation environment; the updated environmental temperature value T and the updated environmental relative humidity value RH are transmitted to the control module; and an updated leaf VPD value is calculated from the updated environmental temperature value T and the updated environmental relative humidity value RH by the processing unit of the control module.

According to an embodiment of the invention, the updated leaf VPD value is compared with the pre-determined VPD threshold value again to adjust the running modes of the heater and the fan to adjust control the leaf VPD within the indoor cannabis cultivation environment; and the control module transmits the heater control signal to the heater and the fan control signal to the fan to adjust the environmental temperature value T and the environmental relative humidity value RH within the indoor cannabis cultivation environment.

According to an embodiment of the invention, a heating device with VPD control for indoor residential cannabis cultivation is disclosed. The heating device with VPD control includes: a power unit for providing electric power to the heating device with VPD control for indoor residential cannabis cultivation; a DC fan driven by a DC motor, wherein the DC fan includes a plurality of fan speed gears under a fan mode; a heater for providing heat to the heating device with VPD control for indoor residential cannabis cultivation, wherein the heater includes a plurality of heating power gears under a heating mode; an IO interface for input and output of control information and status information; a temperature-humidity sensor for sensing an environmental temperature value T and an environmental relative humidity value RH within an indoor cannabis cultivation environment, wherein a leaf VPD value is calculated from the environmental temperature value T and the environmental relative humidity value RH; and a main control unit for communicating with and controlling the power unit, the DC fan, the DC motor, the heater, the IO interface, and the temperature-humidity sensor, wherein, in a VPD heating mode of the heating device with VPD control, the leaf VPD value calculated from the environmental temperature value T and the environmental relative humidity value RH is implemented to control the heating device with VPD control for indoor residential cannabis cultivation.

According to an embodiment of the invention, the leaf VDP is calculated from the environmental temperature value T and the environmental relative humidity value RH by: Leaf VPD=610.78 e\hat{ }(17.2694 (T+Leaf offset)/(237.3+T+Leaf Offset))−610.78 e\hat{ }(17.2694 T/(237.3+T))×RH/100, VPD unit is in Pa, T is temperature of the air in degrees Celsius, RH is relative humidity of air in % unit and e≈2.71828.

According to an embodiment of the invention, when the Leaf Offset is defaulted to 0° C., the leaf VPD value is calculated from the environmental temperature value T and the environmental relative humidity value RH via: Leaf VPD=610.78 e\hat{ }(17.2694 T/(237.3+T)) (1−RH/100), Leaf VPD unit is in Pa, T is temperature of the air in degrees Celsius, RH is relative humidity of air in % unit and e≈2.71828.

According to an embodiment of the invention, the user can set a Leaf Offset value between −10° C. and 10° C.

According to an embodiment of the invention, in an VPD heating mode, when the leaf VPD is lower than or equal to a predetermined threshold VPDs, the heating power gear is increased gradually to a Max-level heating power gear set in the ON heating mode, wherein when the leaf VPD is greater than the predetermined threshold VPDs, the heating power gear is decreased gradually to a Min-level heating power gear set in the OFF heating mode.

According to an embodiment of the invention, in an AUTO heating mode, a temperature threshold value is set between 32° F. (0° C.) to 194° F. (90° C.) using the IO interface, when the environmental temperature value T is lower than or equal to the temperature threshold value, the heating power gear is increased gradually to the Max-level heating power gear set in the ON heating mode, when the environmental temperature value T is greater than the temperature threshold value, the heating power gear is decreased gradually to the Min-level heating power gear set in the OFF heating mode.

According to an embodiment of the invention, in a TIMER heating mode, a countdown timer is set using the IO interface, wherein when the countdown time is not zero, the Max-level heating power gear is run, wherein when the countdown time reaches zero, the Min-level heating power gear is run.

According to an embodiment of the invention, in a CYCLE heating mode, an ON-time is set, and an OFF-time is set using the IO interface, wherein during the ON-time, the Max-level heating power gear is run, wherein during the OFF-time, the Min-level heating power gear is run.

According to an embodiment of the invention, a heating device with VPD control enclosed in an enclosure for an indoor residential cannabis cultivation environment is disclosed. The heating device with VPD control includes: a front cover of the enclosure; a rear cover of the enclosure; a U-shaped top cover of the enclosure; a bottom cover of the enclosure; a control panel with a display screen mounted on the front cover of the enclosure; a control module integrated into the control panel with a user IO interface for input and output of control information; a heater enclosed in the enclosure, wherein the heater is implemented for providing heat in response to a heater control signal from the control module; a fan enclosed in the enclosure, wherein the fan is implemented for circulating heat out of the enclosure into the indoor residential cannabis cultivation environment in response to a fan control signal from the control module; and a temperature-humidity sensor outside the enclosure for sensing an environmental temperature value T and an environmental relative humidity value RH within the indoor cannabis cultivation environment.

According to an embodiment of the invention, the environmental temperature value T and the environmental relative humidity value RH are transmitted to the control module in real time, and a leaf VPD value is calculated from the environmental temperature value T and the environmental relative humidity value RH by the processing unit of the control module.

According to an embodiment of the invention, the heating device with VPD control enclosed in an enclosure for an indoor residential cannabis cultivation environment also includes: a hose for transiting hot air generated by the heater into the indoor residential cannabis cultivation environment, wherein the hose is connected to the heater via a connector; an air outlet connected to the hose; and an outlet extension connected to the air outlet, wherein the hose, the air outlet and the outlet extension are housed within the U-shaped top cover of the enclosure.

According to an embodiment of the invention, the heating device with VPD control enclosed in an enclosure for an indoor residential cannabis cultivation environment also includes: an air inlet on the rear cover of the enclosure covered with a mesh, wherein when the heater and the fan are started, air in the indoor residential cannabis cultivation environment is supplied to the heater and the fan through the air inlet.

According to an embodiment of the invention, the heating device with VPD control enclosed in an enclosure for an indoor residential cannabis cultivation environment also includes: a USB-C connector mounted on the rear cover of the enclosure for connecting an external controller to the control module in the enclosure for additional controls.

According to an embodiment of the invention, the heating device with VPD control enclosed in an enclosure for an indoor residential cannabis cultivation environment also includes: an audio headphone jack mounted on the rear cover of the enclosure for connecting to the temperature-humidity sensor outside the enclosure.

According to an embodiment of the invention, the heating device with VPD control enclosed in an enclosure for an indoor residential cannabis cultivation environment also includes: a PCBA box inside the enclosure for housing power supply circuit boards.

According to an embodiment of the invention, the heating device with VPD control enclosed in an enclosure for an indoor residential cannabis cultivation environment also includes: a notch in the front cover of the enclosure or the rear cover of the enclosure.

### BRIEF DESCRIPTION OF THE FIGURES

The invention will now be explained in more detail using exemplary embodiments and with references to the drawings, in which:

FIG. 1A is an exploded view of the heating device with VPD control, according to an embodiment of the invention.

FIG. 1B is a front view of the heating device with VPD control, according to an embodiment of the invention.

FIG. 1C is a rear view of the heating device with VPD control, according to an embodiment of the invention.

FIG. 1D is a front view of the heating device with VPD control with the front cover removed, according to an embodiment of the invention.

FIG. 1E is a rear view of the heating device with VPD control with the rear cover removed, according to an embodiment of the invention.

FIG. 2 is a block diagram of the heating device with VPD control, according to an embodiment of the invention.

FIG. 3 is a chunk of sample code of the heating device with VPD control, according to an embodiment of the invention.

FIG. 4 is a chart illustrating the relationship among VPD, temperature and relative humidity in cannabis cultivation, according to an embodiment of the invention.

FIG. 5 is flowchart of the heating method with VPD control in heating mode, according to an embodiment of the invention.

FIG. 6 is a flowchart of the equipment error warnings, according to an embodiment of the invention.

### DETAILED DESCRIPTION OF PREFERRED EMBODIMENTS

The invention is susceptible of many embodiments. Preferred embodiments are illustrated in the attached figures and explained below. Minor variations of the preferred embodiments are evident in the figures, but are substantially the same, with common or similar components and the same reference numbers, except as noted.

The saturation vapor pressure deficit of an air sample (sometimes “vapor pressure deficit, VPD” or just “saturation deficit” for short) is the difference between the saturation vapor pressure and the actual vapor pressure at temperature T, i.e., SVP (Saturation Vapor Pressure)−AVP (Actual Vapor Pressure). VPD is the difference between moisture that is currently in the air and how much moisture the air can hold at saturation, or dew point under certain conditions. In ecological problems, VPD is often regarded as a measure of the “drying power” of air, because it plays an important part in determining the relative rates of growth and transpiration in plants. In micrometeorology, the vertical gradient of saturation deficit is a measure of the lack of equilibrium between a wet surface and the air passing over it. Vapor Pressure Deficit (“VPD”) plays a crucial role in plant indoor cultivation, especially high valued plants, such as cannabis.

Air VPD can be calculated from relative air humidity RH and temperature Ta. By definition, air VPD=SVP (Saturation Vapor Pressure)−AVP (Actual Vapor Pressure), SVP is the “Saturation Vapor Pressure” and AVP is the “Actual Vapor Pressure”.

$$a . SVP = 610.78 {e}^{17.2694 \frac{T}{237.3 + T}} ,$$

wherein, 610.78, 17.2694 and 237.3 are constants, and T is temperature of the air in degrees Celsius.

$$b . AVP = 610.78 {e}^{17.2694 \frac{T}{237.3 + T}} \frac{R H}{100} ,$$

wherein, RH is the relative humidity of air in % unit, and 610.78, 17.2694 and 237.3 are constants, Tis temperature of the air in degrees Celsius.

$$c . Air VPD = S V P - A V P = 610.78 {e}^{17.2694 \frac{T}{237.3 + T}} ( 1 - \frac{R H}{100} ) ,$$

wherein, VPD unit is in Pa, T is temperature of the air in degrees Celsius. RH is the relative humidity of air in % unit, e≈2.71828.

The SVP value can be calculated by, for example, the following code:

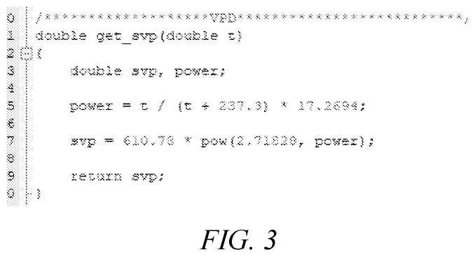

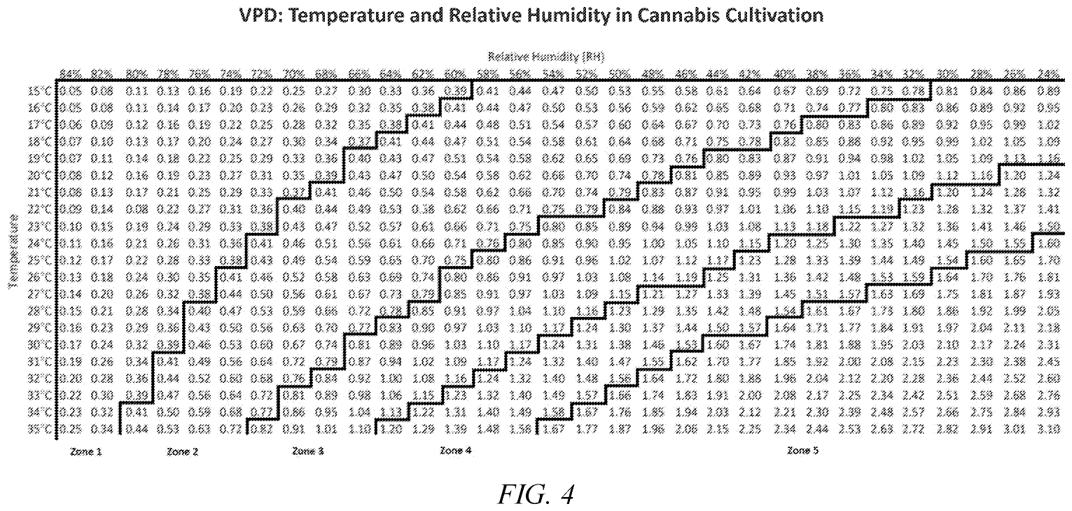

which is also illustrated in FIG. 3. According to the embodiment in the code above, FIG. 4 shows the code for calculating the saturated vapor pressure SVP (Saturation Vapor Pressure) from a temperature of the air T. the unit is Pa, on the display, it is possible to display either Pa or kPa, or other units if appropriate.

According to another embodiment of the invention, the VPD can be calculated by following the steps below:
a. Obtaining real time air temperature T (° C.) and real time relative humidity RH, obtaining Leaf Offset, which is defaulted to zero and can be set by the user within the recommended range: −10° C.≈10° C.;
b. Calculating the leaf temperature Leaf T=T+Leaf Offset, wherein T (° C.) is real time air temperature, Leaf T (° C.) is leaf temperature, Leaf Offset is the difference between the leaf and the air temperature, Leaf Offset=Leaf T−Air T;
c. Calculating ASVP, which is the air SVP, wherein ASVP=610.78×e\hat{ }(T/(T+237.3)×17.2694);
d. Calculating LSVP, which is the leaf SVP, wherein LSVP=610.78×e\hat{ }((T+Leaf Offset)/(T+Leaf Offset+237.3)×17.2694);
e. Calculating leaf VPD, wherein Leaf VPD=LSVP−(ASVP×RH/100);
f. Calculating real time Leaf VPD, wherein Leaf VPD=LSVP−ASVP×RH/100=610.78×e\hat{ }((T+Leaf Offset)/(T+Leaf Offset+237.3)×17.2694)−610.78 ×(e\hat{ }(T/(T+237.3)×17.2694))×H/100, wherein the unit of Leaf VPD is Pa, the unit of temperature is ° C., the unit of RH is %, and e≈2.71828.
   The default value of Leaf Offset is 0, which means that T+Leaf Offset=T in the above equations, and the default value of the leaf VPD is equal to air VPD, i.e., under the default condition, Leaf VPD=610.78 ×e\hat{ }(T/(T+237.3)×17.2694)×RH/100.

VPD in Cannabis Cultivation. Plants respond to changes in water availability in both their aerial and soil environments. The driving force of transpiration rate is the gradient in vapour pressure between the dry atmosphere and the wet interior of leaves, which is referred to as VPD as discussed above.

A high VPD indicates a hotter and drier environment, while a low VPD results from a cooler and more humid environment. Scientific studies have demonstrated that the cannabis is highly responsive to changes in VPD, and VPD has been identified as a critical factor influencing transpiration and stomatal conductance in crops including cannabis.

For cannabis growers with indoor grow tents or rooms with artificial lighting, in addition to temperature and relative humidity parameters, it is critical to take into consideration the importance of VPD and its impact on transpiration or nutrient uptake. For example, as illustrated in FIG. 4, in the chart depicting the relationship between temperature, humidity and VPD below, there are five zones: zone 1 through zone 5, with different combinations of temperature and relative humidity values. For example, zone 1: danger zone; zone 2: blue zone for low transpiration stage, propagation stage and early vegetative stage; zone 3: green zone for optimized healthy growth during transpiration stage, late vegetative state, and early flower stage; zone 4: yellow zone for high transpiration stage and late flower stage; zone 5: danger zone. Among these zones, zone 3 is the optimal zone with ideal combinations of temperature and relative humidity value for cannabis plants. For different stages, such as growth and flowering stages, temperature, relative humidity, and the recommended leaf VPD values are listed in the chart in FIG. 4.

Different VPD values are recommended for different stages of the plant. For example, for VPD value between 1.20 kPa and 1.60 kPa, which is considered relatively high, plants tend to open their stomata and release a considerable amount of water vapour into the environment to increase their transpiration. This increase in transpiration results in an increase in the plant's photosynthetic activity and will improve its overall growth during both growth and bloom. The optimal VPD range is between 0.80 kPa and 1.20 kPa. When the VPD is too high, the plant closes its stomata to avoid releasing excessive amount of the water vapor into the environment. Excessive transpiration causes dehydration. On the other hand, when VPD is too low, the atmosphere is already saturated and has reached the maximum water retention capacity, the plant will also close its stomata to avoid releasing too much water vapor into the atmosphere. Decreased transpiration reduces photosynthesis, slowing the plant's development and lowering yield.

There are two types of VPD's: air VPD and leaf VPD. Leaf VPD is what is been calculated in the present invention, which assumes that a leaf surface temperature is the same as the air temperature. This may not, however, always be the case due to external factors, such as light shining on a leaf causing it to heat up. According to the embodiment of the invention, there is an option in the heater settings to allow users to measure and input the leaf surface temperature in relation to the air temperature (leaf offset), which will change the Air VPD reading to an estimated leaf VPD reading.

A PTC, or semiconductor, is a ceramic-based electrical component with temperature-dependent resistance that is used as a heating element. PTC's positive temperature coefficient allows electrical current to flow better at low temperatures than at high temperatures. As the temperature rises, the PTC's natural resistance increases while its current conductivity and power output decrease until a state of equilibrium is reached and the current can barely flow anymore, which is the so-called PTC effect. Due to their self-regulating characteristic, PTC heating elements cannot overheat, making PTC heating technology particularly safe and reliable.

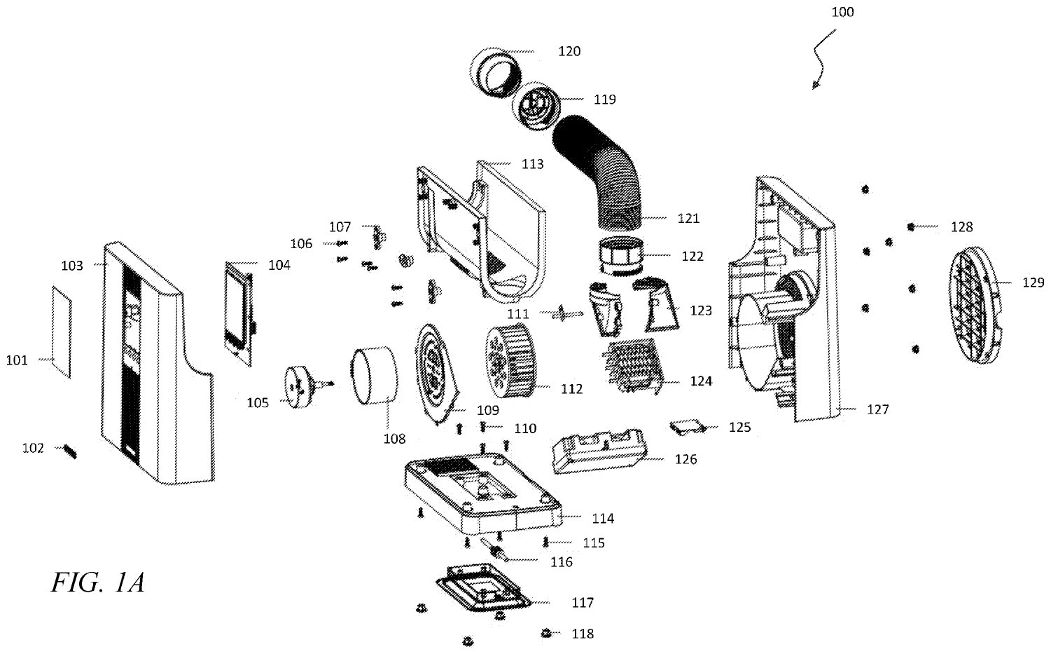

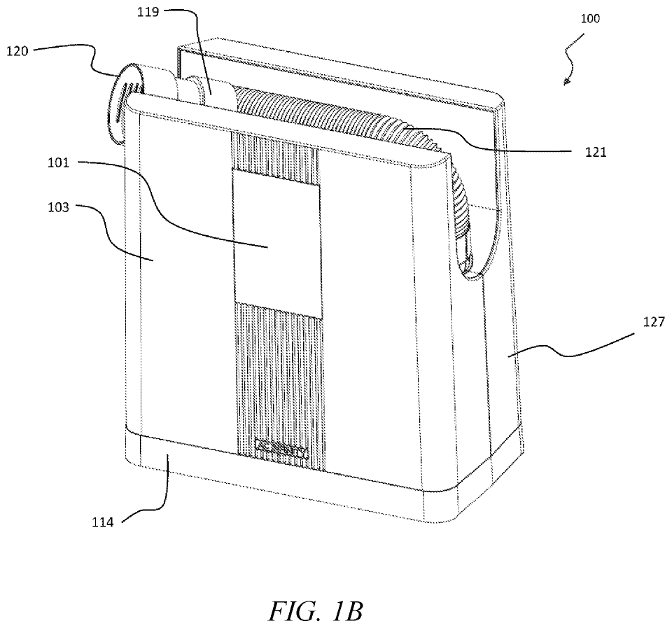

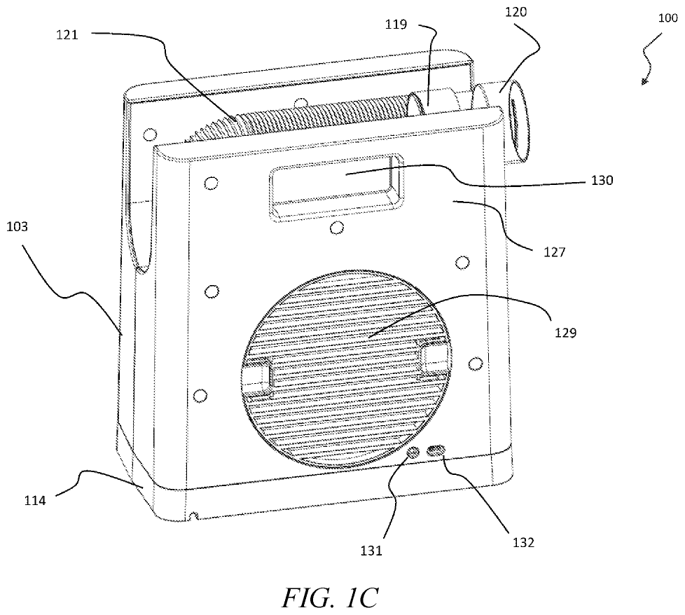

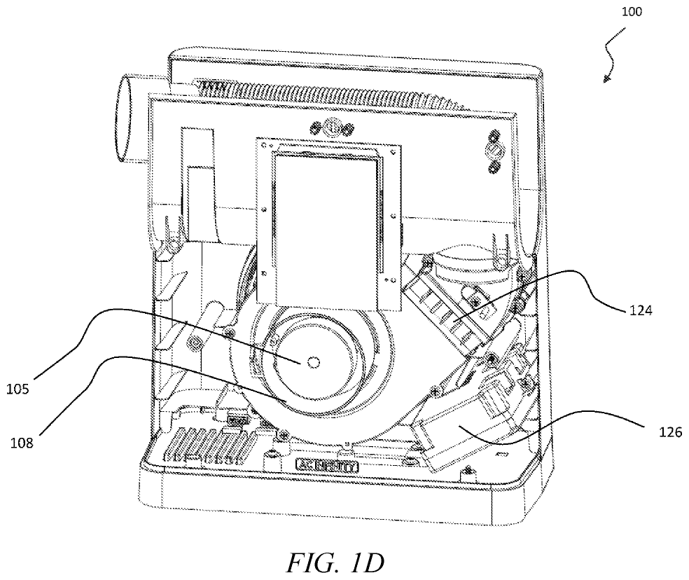

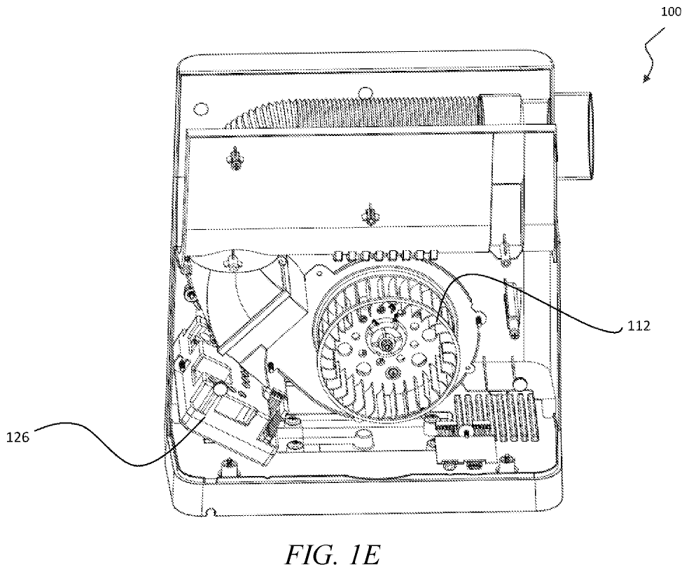

FIG. 1A is an exploded view of the heating device with VPD control 100, according to an embodiment of the invention. According to an embodiment of the invention, VPD control means increasing VPD. In the exploded view of heating device with VPD control 100 as illustrated in FIG. 1, the elements of the heating device with VPD control 100 are enclosed inside the box defined by the front cover 103, the rear cover 127, the U-shaped cover 113 and the bottom base 114. On the front cover 103, a control panel 104 is mounted, which is protected by a piece tempered glass with a matching size. The control panel 104 includes a display screen, which can be a touch screen for input and output of control parameters and other information. A logo 102 is also mounted on the front cover 103. A rear mesh 129 is mounted on the rear cover 127 to protect the air inlet. Screw hole rubber plugs 128 are used to plug the screw hole on the rear cover 127.

Within the enclosure box, the heating device with VPD control includes a DC motor 105 for driving a fan 112 to properly circulate hot air generated by a heater 124. All the electric components, such as the motor and the heater, are powered by batteries mounted inside a PCBA box 126 and controlled by a main control unit which is integrated into the control panel 104. According to an embodiment of the invention, the control panel 104 includes a main control board. On the main control board, there is the chip on which all the mode control algorithms are stored. 126 is a PCBA box (power supply box), where houses the power supply circuit board. The main control unit can be a minicomputer, a logic device, a programmable logic circuit, a PCBA (printed circuit board assembly), a Field Programmable Gate Array (FPGA), or the equivalents. Alternatively, the heating device with VPD control can be powered by external power, AC or DC.

The electric motor 105 is mounted on motor supports 108 and 109. When the electric motor 105 is turned on, it drives the fan 112 to blow air properly heated by the heater 124 to the telescopic hose 121 through a connector 122 and a wind channel 123. The hose 121 ends with an air outlet 119 and an outlet extension 120. According to some embodiments, the heater 124 is a PTC heater which includes a plurality of PTC heating pieces, such as 111. The hose 121 sits within the U-shape of the U-shaped cover 113 and the U-shaped cover 113 provides support for the hose 121 and the air outlet 119, the outlet extension 120. Various sensors and other devices can be connected to the heating device with VPD control 100 via connectors, such as type-C USB. 125 is a type-C connector PCB mounted on the rear cover 127 for connecting external sensors and other devices. The connector 125 is not limited to USB, the connector can be any other types which are fit for the current purposes. The components are fastened together with appropriate screws, such as 106 and their corresponding screw support. 110 and 115 are also screws. 117 is a bottom cord storage holder that allows the user to unplug the power cord and wrap it around the 117 when the heater is not in use. 118 are foot pads for providing support.

FIG. 1B is a front view of the heating device with VPD control, according to an embodiment of the invention. In the front view, the hose 121 sits within the U-shape of the U-shaped cover 113 and the U-shaped cover 113 provides support for the hose 121 and the air outlet 119, the outlet extension 120. The control panel 104 mounted on the front cover 103 is protected by a rectangular tempered glass 101. The screen of the control panel can be a touch screen and serves as the input output interface for the heating device with VPD control 100 for accepting control input parameters and displaying various information.

FIG. 1C is a rear view of the heating device with VPD control, according to an embodiment of the invention. In the rear view, it is also shown that the hose 121 sits within the U-shape of the U-shaped cover 113 and the U-shaped cover 113 provides support for the hose 121 and the air outlet 119, the outlet extension 120. The mesh 129 covers the air inlet on the rear cover. According to an embodiment of the invention, the rear cover 127 has a notch 130 which is convenient for the user to lift and move the heater device. In addition, the rear cover 127 also includes an audio headphone jack 131 which is implemented to connect to a temperature and humidity sensor, and a TYPE-C port connector 132 which is implemented to connect to the controller. Both connectors can be changed correspondingly in other alternative embodiments.

FIG. 1D is a front view of the heating device with VPD control with the front cover removed, according to an embodiment of the invention. With the front cover removed, FIG. 1D illustrate the deployment of the components inside the heating device with VPD control 100. The soft hose 121 is connected to the electric fan and wound around inside the enclosure to direct the properly heated air out of the heating device with VPD control through the outlet.

FIG. 1E is a rear view of the heating device with VPD control with the rear cover removed, according to an embodiment of the invention. Elements discussed above in FIG. 1D are also shown in FIG. 1E from a rear view.

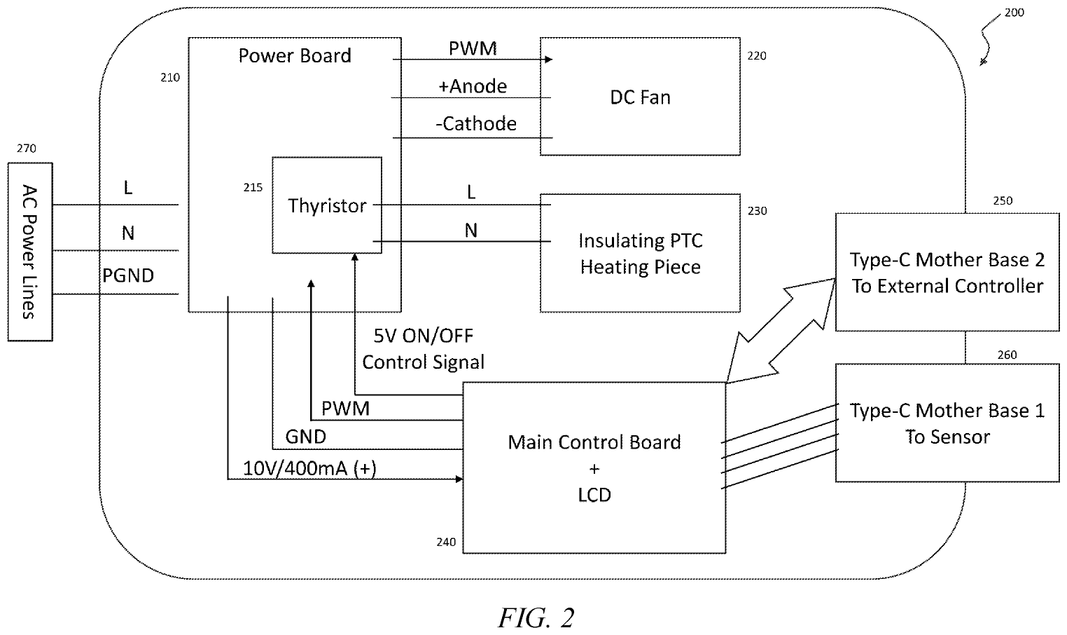

FIG. 2 is a block diagram of the heating device with VPD control, according to anther embodiment of the invention. The heating device with VPD control 200 includes several different modules. The heating device with VPD control 200 includes a power board module 210 which provides power and power controls. The power board module 210 further includes thyristor module 215 which includes thyristors for controlling purposes. The heating device with VPD control 200 includes a DC fan module 220, which further includes, for example, a DC motor and fans. The DC fan module 220 is controlled by, for example, the power board module 210. The control can be achieved by PWM, for example. The heating device with VPD control 200 includes an insulating PTC heating module 230, which further includes a plurality of insulating PTC heating pieces. The heating module 230 is controlled by the power board module 210's thyristor module 215, for example. The insulating PTC heating pieces are turned on and off by appropriate control signals. According to embodiment of the invention, the heating device with VPD control is implemented inside a VPD heater.

The heating device with VPD control 200 includes a main control board module 240 which contains control units such as a minicomputer, or other equivalent logic circuit devices. The main control board module 240 also includes a display screen, such as an LCD screen, or a touch screen, for input and output of control information. The screen can be mounted, for example, on the front cover as illustrated in FIGS. 1A and 1B. The heating device with VPD control 200 also includes connectors to external sensors and controllers, such as a type-C USB connector 250 to external controllers, and a type-C USB connector 260 to external sensors. Both connectors 250 and 260 are connected to the main control board module 240, all sensor signals and control signals are processed in the control unit on the main control board module 240. The main control board module 240 is further connected to the power board module 210 and the thyristor module 215. PWM signal can be used for control of power, for example. The heating device with VPD control 200 can be powered by batteries, or external power, such as AC power through an AC power line module 270. According to an embodiment of the invention, the heating device with VPD control can be connected to an external controller. The buttons on the heating device with VPD control will be disabled when the external controller is connected. The modes and parameters can be switched and adjusted through the external controller.

According to an embodiment of the invention, the power of the heater includes 10 levels, or called gears, the fan speed also has 10 levels, or 10 gears. According to an embodiment of the invention, the heating device with VPD control has a heating mode and a fan mode. The default fan peed if gear-10 when entering the heating mode, heating power can be adjusted from gear-0 to gear-10. The heating gears are detailed in the table below, with fan at default full speed gear-10:

| Heater Gear | Heater Power (W) | Fan Gear | Fan Speed (RPM) |
|---|---|---|---|
| Gear-0 | 0.0 | Gear-10 | 2195 |
| Gear-1 | 138.5 | Gear-10 | 2195 |
| Gear-2 | 180.0 | Gear-10 | 2195 |
| Gear-3 | 227.5 | Gear-10 | 2195 |
| Gear-4 | 258.5 | Gear-10 | 2195 |
| Gear-5 | 293.0 | Gear-10 | 2195 |
| Gear-6 | 332.5 | Gear-10 | 2195 |
| Gear-7 | 372.0 | Gear-10 | 2195 |
| Gear-8 | 417.0 | Gear-10 | 2195 |
| Gear-9 | 456.5 | Gear-10 | 2195 |
| Gear-10 | 500.0 | Gear-10 | 2195 |

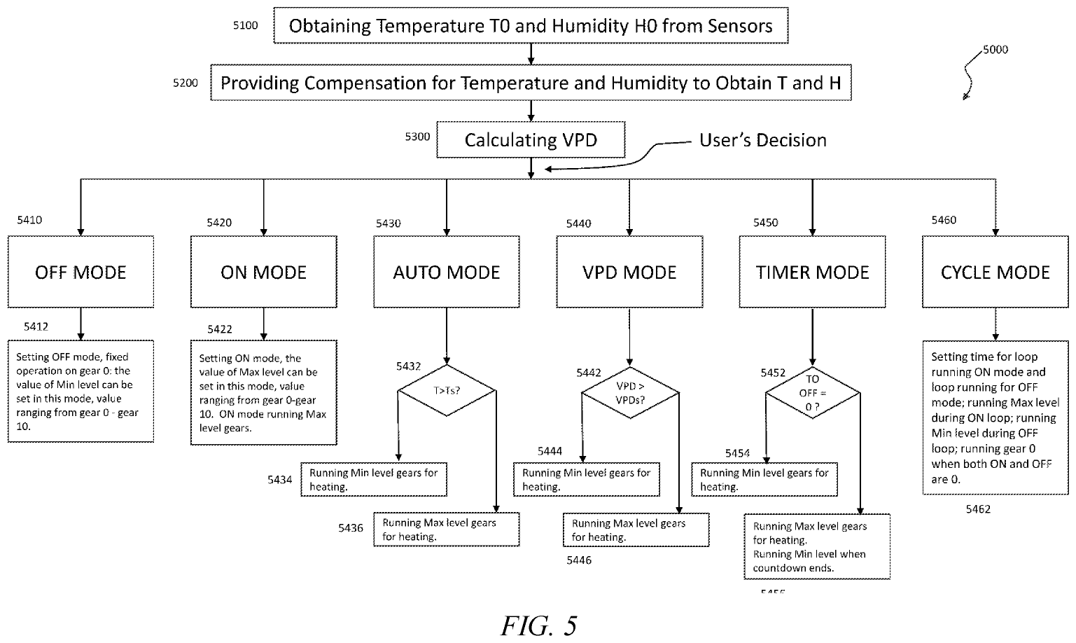

FIG. 5 is flowchart of the VPD control method in heating mode, according to an embodiment of the invention. The VPD control method 5000 includes a first step 5100, obtaining a temperature To and a humidity Ho from sensors. According to the embodiments discussed above, temperature sensors and humidity sensor are deployed inside the indoor growing tent or room with artificial lighting. These temperature sensors and humidity sensors are connected to the control unit in which the temperature and humidity values are received and used to calculate VPD. The second step 5200 is: providing compensation for temperature and humidity to obtain temperature T and relative humidity RH. Then at the third step 5300, calculating VPD using T and RH values. A decision is made to determine which mode to run selected from a plurality of heating modes and fan modes.

According to an embodiment of the invention, there are, for example, six heating modes: OFF mode, ON mode, AUTO mode, VPD mode, TIMER mode and CYCLE mode.
a. The first mode 5410 is OFF mode, in which the step 5412 is performed: setting OFF mode, default heating setting is gear-0, the device is not running. The value of Min level heating power can be set in this mode, value ranging from gear-0 to gear-10. Min level heating power is the customized minimum heating power level in a heating mode.
b. The second mode 5420 is ON mode, in which the step 5422 is performed: setting ON mode, the default heating gear is 6. The value of Max level heating power can be set in this mode, value ranging from gear 0 to gear 10. ON mode runs the Max level heating power gear. Max level heating power is the customized maximum heating power level in a heating mode.
c. The third mode 5430 is AUTO mode, the default setting is OFF, in which temperature T is compared to a predetermined temperature value Tₛ at step 5432. Temperature can be set and changed cyclically from 32° F. (0° C.) to 194° F. (90° C.) by pressing the INCREASE/DECREASE buttons. When a predetermined temperature value Tₛ is set, if the temperature reading T from the sensor is lower than or equal to predetermined temperature value, step 5434 is performed, ON mode is trigged and the heating gear gradually increases to the Max level heating power under ON mode. On the other hand, if the temperature reading T from the sensor is higher than the predetermined value Tₛ, step 5436 is performed, OFF mode is triggered, and the heating gear decreases gradually to the Min level heating power under OFF mode.
d. The fourth mode is VPD mode 5440, in which VPD is compared to a predetermined VPDₛ. VPD value can be set and changed cyclically from 0.0 kPa to 3.0 kPa by pressing the INCREASE/DECREASE buttons. After setting the VPDₛ value, the VDP value calculated from the sensor readings is compared to the predetermined VPDₛ. If VPD is lower than or equal to VPDₛ, step 5446 is performed: ON mode is triggered and heating gear is gradually increases to the Max level heating power under ON mode. Otherwise, if VPD>VPDₛ, step 5444 is performed: OFF mode is triggered, and the heating gear decreases gradually to the Min level heating power under OFF mode.
e. The fifth mode is TIMER mode 5450, in which a TIMER is set and tracked, when the TIMER is not zero, perform step 5456: running Max level heating power gear; when TIMER reaches 0, perform step 5454: running Min level heating power gear; if TIMER is set to 0, continue to run Min level heating power. The TIMER default value is 0:00.
f. The last mode 5460 is CYCLE mode, in which step 5462 is performed: setting ON-time for loop running ON mode and OFF-time for loop running for OFF mode; running Max level heating power during ON loop; running Min level heating power during OFF loop; running gear 0 when both ON-time and OFF-time are 0. The default ON-time and OFF-time are both 0:00. According to an embodiment of the invention, the user can choose gear-2 as the minimum level gear, and gear-7 as the maximum level gear. In AUTO mode, the heater runs gear-2 for heating when the temperature is detected to be higher than the set temperature, and gear-7 for heating when it is lower than the predetermined temperature threshold. Similarly, in VPD mode, TIMER mode and Cycle mode, the heater can run gear-2 and gear-7 as Min level heating power and Max level heating power correspondingly as well.

According to an embodiment of the invention, there are four fan modes: OFF mode, ON mode, TIMER mode and CYCLE mode. In the fan modes, the heater is not turned on, and the fan speed can be adjusted from gear-0 to gear-10. In the fan mode, the heater is turned off. There are 10 fan gears as summarized in the table below:

| Fan Gear | Fan Speed (RPM) | Heater Gear |
|---|---|---|
| Gear-0 | 0 | Gear-0 |
| Gear-1 | 564 | Gear-0 |
| Gear-2 | 746 | Gear-0 |
| Gear-3 | 805 | Gear-0 |
| Gear-4 | 1130 | Gear-0 |
| Gear-5 | 1289 | Gear-0 |
| Gear-6 | 1470 | Gear-0 |
| Gear-7 | 1652 | Gear-0 |
| Gear-8 | 1833 | Gear-0 |
| Gear-9 | 2014 | Gear-0 |
| Gear-10 | 2195 | Gear-0 |

The fan modes are summarised below:
a. OFF mode. The default gear is 0. Under OFF mode, the 4 device does not run. Min level fan speed value can be set in OFF mode, ranging from gear-0 to gear-10.
b. ON mode. The default gear is 6. Under ON mode, Max level fan speed can be set, ranging from gear-0 to gear-10. ON mode runs Max level fan speed gears.
c. TIMER mode. When the TIMER is set to a non-zero value, run Max level fan speed gears during TIMER countdown. After the TIMER expires, run Min level fan speed gears. When the TIMER is set to 0, continue to run Min level fan speed gears. The default TIME value is 0:00.
d. CYCLE mode. Set ON time and OFF time to be run cyclically. During the ON time of the cyclic running, Max level fan speed gears are run, and during the OFF time of the cyclic running, Min level fan speed gears are run. When both ON time and OFF time are set to 0, then gear-0 is run. The default values for both ON time and OFF time are 0:00.

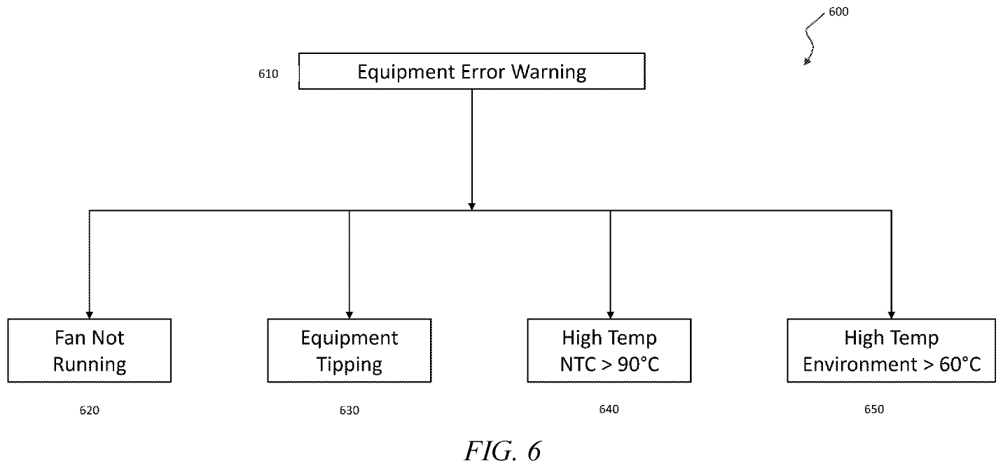

FIG. 6 is a flowchart of the equipment error warnings, according to an embodiment of the invention. The heating device with VPD control discussed above includes an equipment error warning mechanism 600. The equipment error warning 610 is caused by, for example, the following errors: the error 620, fan not running; the error 630, equipment tipping; the error 640, NTC temperature exceeding 90° C.; and the error 650, environmental temperature exceeding 60° C. When any one of the errors happens, the error is reported to the equipment error warning mechanism 610, which displays the corresponding error message(s) on the LCD screen on the front cover.

The heating device with VPD control as discussed above is a specialty device which has not previously been invented specifically for indoor cannabis cultivation, no heater or similar heater with controller as discussed above is on the market as of the day of the filing of this patent application. There exists long-felt market need. The heating device with VPD control as discussed above requires unconventional sensor choices, specialty programming, and modifications to a heater's design to allow it to be integrated into a residential indoor cannabis cultivation space. This long-felt specialty market need is not fulfilled so far by any other designs on the market.

The heating device with VPD control as discussed above requires a redesign of the conventional heater to accept not only the humidity sensor readings, but in addition, it requires it to be able to compute these humidity sensor readings along with the temperature sensor readings to provide an air VPD value. The heater will need to be reprogrammed to be controllable based on the VPD readings instead of just temperature, which is completely novel to the indoor cannabis cultivation heater market. The hardware, firmware, and software all need to be redesigned and redeveloped to accomplish the heating device with VPD control as discussed above, which can also be called a VPD heater for indoor cannabis cultivation, or a heating device with VPD control for indoor cannabis cultivation. The present invention includes several additional unique hardware features added to this specific VPD heater, such as the external sensors, expandable tubing, and air intake fan controls, etc., which are all specifically developed to cater to the indoor residential cannabis cultivation market.

Controlling the environment via VPD that only caters to a specific consumer market, such as the indoor residential cannabis cultivation market, is relatively new. The high cost of setting up an indoor residential cannabis cultivation room or tent has long prevented the market from developing any specialty devices until recently, with the introduction of legalized residential indoor cannabis cultivation across the nation. When combined with the high cost of legally purchasing cannabis, this has led to the rise of consumers looking to start their own residential indoor cannabis cultivation. Financially, with each plant grown having a market value of on average $200-$1000, residential growers are now willing to spend much more on specialty indoor grow devices to improve their plant quality as they can often recapture the cost of expensive indoor cultivation equipment within 3-6 months. This has led to a push for better indoor cultivation equipment to be developed.

The present invention is more focused on the indoor residential cultivation market because commercial indoor growers are still using temperature and humidity devices to fine tune their grow environment in lieu of VPD, but residential growers often lacking the tools needed to maintain both a set temperature and humidity, which would require a humidifier, a dehumidifier, an air conditioner, and a heater. By utilizing VPD, residential growers can eliminate at least one or two of these equipment's while still maintaining the same optimal cultivation environment as long as the temperature and humidity of the cultivation space does not reach extreme levels.

Other and various embodiments within the scope of the invention will be readily evident to practitioners skilled in the art, from specification, figures and claims that follow.

What is claimed is:

1. A heating device with VPD control for indoor residential cannabis cultivation, the heating device with VPD control comprising:
a control module with a processing unit, a display screen and an IO interface;
a heater for providing heat in response to a heater control signal from the control module;
a fan for circulating heat in response to a fan control signal from the control module; and
a temperature-humidity sensor for sensing an environmental temperature value T and an environmental relative humidity value RH within an indoor cannabis cultivation environment,
wherein the environmental temperature value T and the environmental relative humidity value RH are transmitted to the control module in real time, and
wherein a leaf VPD value is calculated from the environmental temperature value T and the environmental relative humidity value RH by the processing unit of the control module.

2. The heating device with VPD control for indoor residential cannabis cultivation of claim 1,
wherein the leaf VPD value is compared with a pre-determined VPD threshold value to determine running modes of the heater and the fan to control the leaf VPD value within the indoor cannabis cultivation environment, and
wherein the control module transmits the heater control signal to the heater and the fan control signal to the fan to adjust the environmental temperature value T and the environmental relative humidity value RH within the indoor cannabis cultivation environment.

3. The heating device with VPD control for indoor residential cannabis cultivation of claim 2,
wherein the temperature-humidity sensor senses an updated environmental temperature value T and an updated environmental relative humidity value RH within the indoor cannabis cultivation environment;
wherein the updated environmental temperature value T and the updated environmental relative humidity value RH are transmitted to the control module; and
wherein an updated leaf VPD value is calculated from the updated environmental temperature value T and the updated environmental relative humidity value RH by the processing unit of the control module.

4. The heating device with VPD control for indoor residential cannabis cultivation of claim 3,
wherein the updated leaf VPD value is compared with the pre-determined VPD threshold value again to adjust the running modes of the heater and the fan to control the leaf VPD within the indoor cannabis cultivation environment; and
wherein the control module transmits the heater control signal to the heater and the fan control signal to the fan to adjust the environmental temperature value T and the environmental relative humidity value RH within the indoor cannabis cultivation environment.

5. A heating device with VPD control for indoor residential cannabis cultivation, the heating device with VPD control comprising:
a power unit for providing electric power to the heating device with VPD control for indoor residential cannabis cultivation;
a DC fan driven by a DC motor, wherein the DC fan includes a plurality of fan speed gears under a fan mode;
a heater for providing heat to the heating device with VPD control for indoor residential cannabis cultivation, wherein the heater includes a plurality of heating power gears under a heating mode;
an IO interface for input and output of control information and status information;
a temperature-humidity sensor for sensing an environmental temperature value T and an environmental relative humidity value RH within an indoor cannabis cultivation environment, wherein a leaf VPD value is calculated from the environmental temperature value T and the environmental relative humidity value RH; and
a main control unit for communicating with and controlling the power unit, the DC fan, the DC motor, the heater, the IO interface, and the temperature-humidity sensor, wherein, in a VPD heating mode of the heating device with VPD control, the leaf VPD value calculated from the environmental temperature value T and the environmental relative humidity value RH is implemented to control the heating device with VPD control for indoor residential cannabis cultivation.

6. The heating device with VPD control for indoor residential cannabis cultivation of claim 5,
wherein the leaf VDP is calculated from the environmental temperature value T and the environmental relative humidity value RH by:
$$Leaf VPD = 610.78 {e}^{17.2694 \frac{T + L eaf offset}{237.3 + T + L eaf offset}} - 610.78 {e}^{17.2694 \frac{T}{237.3 + T}} \times \frac{R H}{100} ,$$
wherein, VPD unit is in Pa, T is temperature of the air in degrees Celsius, RH is relative humidity of air in % unit and e≈2.71828.

7. The heating device with VPD control for indoor residential cannabis cultivation of claim 6, wherein when the Leaf Offset is defaulted to 0° C., the leaf VPD value is calculated from the environmental temperature value T and the environmental relative humidity value RH via:
$$Leaf VPD = 610.78 {e}^{17.2694 \frac{T}{237.3 + T}} ( 1 - \frac{R H}{100} ) ,$$
wherein, Leaf VPD unit is in Pa, T is temperature of the air in degrees Celsius, RH is relative humidity of air in % unit and e≈2.71828.

8. The heating device with VPD control for indoor residential cannabis cultivation of claim 6, wherein the user can set a Leaf Offset value between −10° C. and 10° C.

9. The heating device with VPD control for indoor residential cannabis cultivation of claim 7, wherein in an VPD heating mode, when the leaf VPD is lower than or equal to a predetermined threshold VPDs, the heating power gear is increased gradually to a Max-level heating power gear set in the ON heating mode, wherein when the leaf VPD is greater than the predetermined threshold VPDs, the heating power gear is decreased gradually to a Min-level heating power gear set in the OFF heating mode.

10. The heating device with VPD control for indoor residential cannabis cultivation of claim 7, wherein in an AUTO heating mode, a temperature threshold value is set between 32° F. (0° C.) to 194° F. (90° C.) using the IO interface, when the environmental temperature value T is lower than or equal to the temperature threshold value, the heating power gear is increased gradually to the Max-level heating power gear set in the ON heating mode, when the environmental temperature value Tis greater than the temperature threshold value, the heating power gear is decreased gradually to the Min-level heating power gear set in the OFF heating mode.

11. The heating device with VPD control for indoor residential cannabis cultivation of claim 7, wherein in a TIMER heating mode, a countdown timer is set using the IO interface, wherein when the countdown time is not zero, the Max-level heating power gear is run, wherein when the countdown time reaches zero, the Min-level heating power gear is run.

12. The heating device with VPD control for indoor residential cannabis cultivation of claim 7, wherein in a CYCLE heating mode, an ON-time is set, and an OFF-time is set using the IO interface, wherein during the ON-time, the Max-level heating power gear is run, wherein during the OFF-time, the Min-level heating power gear is run.

13. A heating device with VPD control enclosed in an enclosure for an indoor residential cannabis cultivation environment, the heating device with VPD control comprising:
a front cover of the enclosure;
a rear cover of the enclosure;
a U-shaped top cover of the enclosure;
a bottom cover of the enclosure;
a control panel with a display screen mounted on the front cover of the enclosure;
a control module integrated into the control panel with a user IO interface for input and output of control information;
a heater enclosed in the enclosure, wherein the heater is implemented for providing heat in response to a heater control signal from the control module;
a fan enclosed in the enclosure, wherein the fan is implemented for circulating heat out of the enclosure into the indoor residential cannabis cultivation environment in response to a fan control signal from the control module; and
a temperature-humidity sensor outside the enclosure for sensing an environmental temperature value T and an environmental relative humidity value RH within the indoor cannabis cultivation environment.

14. The heating device with VPD control enclosed in an enclosure for an indoor residential cannabis cultivation environment of claim 13,
wherein the environmental temperature value T and the environmental relative humidity value RH are transmitted to the control module in real time, and
wherein a leaf VPD value is calculated from the environmental temperature value T and the environmental relative humidity value RH by the processing unit of the control module.

15. The heating device with VPD control enclosed in an enclosure for an indoor residential cannabis cultivation environment of claim 13, further comprises:
a hose for transiting hot air generated by the heater into the indoor residential cannabis cultivation environment, wherein the hose is connected to the heater via a connector;
an air outlet connected to the hose; and
an outlet extension connected to the air outlet, wherein the hose, the air outlet and the outlet extension are housed within the U-shaped top cover of the enclosure.

16. The heating device with VPD control enclosed in an enclosure for an indoor residential cannabis cultivation environment of claim 13, further comprises:
an air inlet on the rear cover of the enclosure covered with a mesh, wherein when the heater and the fan are started, air in the indoor residential cannabis cultivation environment is supplied to the heater and the fan through the air inlet.

17. The heating device with VPD control enclosed in an enclosure for an indoor residential cannabis cultivation environment of claim 13, further comprises:
a USB-C connector mounted on the rear cover of the enclosure for connecting an external controller to the control module in the enclosure for additional controls.

18. The heating device with VPD control enclosed in an enclosure for an indoor residential cannabis cultivation environment of claim 13, further comprises:
an audio headphone jack mounted on the rear cover of the enclosure for connecting to the temperature-humidity sensor outside the enclosure.

19. The heating device with VPD control enclosed in an enclosure for an indoor residential cannabis cultivation environment of claim 13, further comprises: a PCBA box inside the enclosure for housing power supply circuit boards.

20. The heating device with VPD control enclosed in an enclosure for an indoor residential cannabis cultivation environment of claim 13, further comprises: a notch in the front cover of the enclosure or the rear cover of the enclosure.
